(19) United States
(12) Patent Application Publication
(10) Pub. No.: US 2008/0285468 A1
(43) Pub. Date: Nov. 20, 2008

(54) Method and computer-readable medium for detecting abnormal packet in VoIP

(75) Inventors: Dong-Won Seo, Anyang-city (KR); Hee-Jo Lee, Namyangju-city (KR)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: KOREA UNIVERSITY INDUSTRY AND ACADEMY COLLABORATION FOUNDATION

(21) Appl. No.: 12/075,016

(22) Filed: Mar. 7, 2008

(30) Foreign Application Priority Data
May 15, 2007 (KR) 10-2007-0046950

(51) Int. Cl. H04L 12/26

(52) U.S. Cl. 370/242

(57) ABSTRACT

In a session initiation protocol (SIP) corresponding to one of protocols for the voice over Internet protocol (VoIP), an exception detection module acquires a packet for session establishment. If each of fields of the header of the packet is out of a defined character length and includes at least one prohibited character, the exception detection module discards the packet.

The exception detection module confirms a state of the session. If the packet is acquired more than a predetermined number of times in the state of the session, the exception detection module considers the packet to be abnormal and discards the packet.

### BACKGROUND OF THE INVENTION

(a) Field of the Invention

The present invention relates to a method for detecting abnormal packets in voice over Internet protocol (VoIP).

(b) Description of the Related Art

H.323 and a session initiation protocol (SIP) may be cited as examples of protocols for connecting a session in the voice over Internet protocol (VoIP). It is more complex to establish and disconnect connection in the H.323 than in the SIP, and it is more difficult to embody the H.323 than the SIP. Therefore, the SIP that has lower complexity and better extendibility than the H.323 is used in a service for the VoIP.

However, various weaknesses from offending VoIP users to paralyzing the VoIP service exist. An SIP attack and a real-time transportation protocol (RTP) attack may be cited as attacks of the VoIP. The RTP is a protocol for transmitting voice data after connecting a session.

An SIP flooding attack, a malformed SIP message attack, and a spoofing attack may be cited as SIP attacks. The SIP flooding attack is similar to a denial of service (DoS) attack, the malformed SIP message attack maliciously changes contents of the SIP header, and the spoofing attack hides or disguises information on an attacker. An RTP flooding attack, a media spamming attack and a man in the middle (MITM) attack may be cited as RTP attacks. The RTP flooding attack transmits a great quantity of voice information to a specified user, the media spamming attack transmits voice advertisements, and the MITM attack eavesdrops by intercepting packets transmitted between users.

Most VoIP attack tools existing in the Internet are packet generator s for enabling the SIP flooding attack or tools for randomly altering contents of an SIP header field. With regard to the spoofing attack and the MITM attack, their processes are complex and their success probability is low. However, with regard to an abnormal SIP message attack and the SIP message flooding attack, since public tools can vary attack methods and enable easy attacks, they are dangerous.

Research and papers regarding weakness of VoIP based on the SIP exist, but VoIP services embodying them do not exist or even if they do exist, the level is insufficient.

### SUMMARY OF THE INVENTION

The present invention has been made in an effort to provide a method and a computer-readable medium storing a program for detecting weakness of voice services based on a packet such as in the VoIP.

According to an exemplary embodiment of the present invention, in a computer-readable medium that stores instructions executable by at least one processor to perform a method, the method comprises acquiring a packet; determining whether a header of the packet violates a first rule; if the header of the packet does not violate the first rule, confirming a session of the packet; confirming a state of the session; determining whether acquiring the packet in the state of the session violates a second rule; and if the second rule is violated, considering the packet to be abnormal.

In this case, the determining whether acquiring the packet in the state of the session violates the second rule may comprise determining whether the packet is acquired more than a predetermined number of times in the state of the session by acquiring the packet, and the considering the packet to be abnormal may comprise considering the packet to be abnormal if the packet is acquired more than the predetermined number of times in the state of the session.

Also, the determining whether the header of the packet violates the first rule may comprise determining whether each of fields of the header of the packet is out of a defined character length; and determining whether each of fields of the header of the packet includes at least one prohibited character.

A method for detecting an abnormal packet according to an exemplary embodiment of the present invention comprises acquiring a packet for session establishment; confirming a session to which the packet belongs; confirming a state of the session; determining whether the packet is received more than a predetermined number of times in the state of the session by acquiring the packet; and if the packet is received more than a predetermined number of times in the state of the session, considering the packet to be abnormal.

A method for detecting an abnormal packet according to an exemplary embodiment of the present invention comprises acquiring a packet for session establishment; determining whether each of fields of the header of the packet is out of a defined character length; determining whether the each of fields of the header of the packet includes at least one prohibited character; if each of the fields is not out of the defined character length and does not include at least one prohibited character, confirming a session to which the packet belongs; confirming a state of the session; determining whether acquiring the packet in the state of the session violates a predetermined rule; and if the predetermined rule is violated, considering the packet to be abnormal.

### BRIEF DESCRIPTION OF THE DRAWINGS

FIG. 1 is a flow chart representing the calling procedure according to an exemplary embodiment of the present invention.

FIG. 2 is a block diagram representing the SIP exception detection module according to an exemplary embodiment of the present invention.

FIG. 3 is a flow chart representing the SIP exception detection method according to an exemplary embodiment of the present invention.

FIG. 4 is a drawing representing the SIP packet rules according to an exemplary embodiment of the present invention.

FIG. 5 is a state transition diagram representing the method for the INVITE client to manage the state of the session according to an exemplary embodiment of the present invention.

FIG. 6 is a state transition diagram representing the method for the INVITE server to manage the state of the session according to an exemplary embodiment of the present invention.

FIG. 7 is a state transition diagram representing the method for the non-INVITE client to manage the state of the session according to an exemplary embodiment of the present invention.

FIG. 8 is a state transition diagram representing the method for the non-INVITE server to manage the state of the session according to an exemplary embodiment of the present invention.

FIG. 9 is a graph showing the effectiveness of the exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Unless explicitly described to the contrary, the word “comprise” will be understood to imply the inclusion of stated elements but not the exclusion of any other elements. In addition, the word “unit” will be understood to be for processing a predetermined function or operation, which may be realized by hardware, software, or a combination thereof.

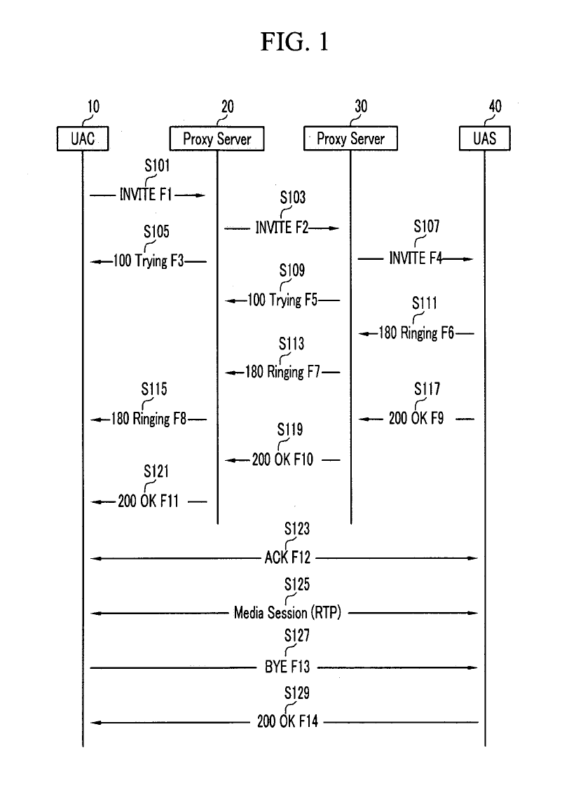

A calling procedure according to an exemplary embodiment of the present invention will be now described with reference to FIG. 1.

FIG. 1 is a flow chart representing the calling procedure according to an exemplary embodiment of the present invention.

As shown in FIG. 1, a system for SIP comprises a user agent client (UAC) 10 corresponding to a caller, a proxy server 20, a proxy server 30 and a user agent server (UAS) 40 corresponding to a callee.

A request message and a response message may be cited as examples of an SIP message. For describing SIP messages, the UAC 10 will be called a client, and each of the proxy server 20, the proxy server 30 and the UAS 40 will be called a server.

The request message is a message that the client transmits to a server. An INVITE request message, an ACK message, a BYE request message, a CANCEL request message, a REGISTER request message and an OPTIONS request message may be cited as examples of the request message.

The INVITE request message is a message that the UAC 10 transmits so as to invite the UAS 40.

The ACK message is a message for confirming that the UAC 10 received an OK response message of the UAS 40

The BYE request message is a message that the UAC 10 or the UAS 40 transmits to the opposite party so as to close a call.

The CANCEL request message is a message for withdrawing a request that is not already completed. For example, in a case in which the UAC 10 transmits the INVITE request message to the UAS 40 so as to request a call to the UAS 40, the UAC 10 transmits the CANCEL request message so as to cancel the call.

The REGISTER request message is a message that the client transmits so as to register location information, an SIP address, or an Internet protocol (IP) address in the server.

The OPTIONS request message is a message that the client transmits so as to request information on the server.

In other words, the response message is a message that the server generally transmits to the client. A provisional response message, a success response message, a redirection response message, a client error response message, a server error response message and a global failure response message may be cited as examples of the response message.

The provisional response message is a message corresponding to a response code of 1XX (100˜199). The provisional response message is a message that the server notes that it receives and processes the request message. A trying response message corresponding to the response code of 100 among the provisional response messages is a message for noting that the request message has not arrived at a final destination. The ringing response message corresponding to the response code of 180 among the provisional response messages is a message for noting that the request message has arrived at a final destination and is in a state of waiting for processing.

The success response message corresponding to the response code of 2XX (200˜299) is a message for noting that the server has successfully received, understood, and accepted the request message. The OK response message corresponding to the response code of 200 among the success response messages is a message for noting that the UAS 40 has accepted the request.

The redirection response message corresponding to the response code of 3XX (300˜399) is a message for noting that additional operations are needed for completing the request corresponding to the request message.

The client error response message corresponding to the response code of 4XX (400˜499) is a message for noting that the request message includes errors or the server does not have the ability to process the request message.

The server error response message corresponding to the response code of 5XX (500˜599) is a message for noting that the request message is valid but the server does not have the ability to process the request message.

The global failure response message corresponding to the response code of 6XX (600˜699) is a message for noting that the request corresponding to the request message cannot be processed by any server.

As shown in FIG. 1, the UAC 10 transmits the INVITE request message to the proxy server 20 in step S101.

Next, the proxy server 20 transmits the INVITE request message to the proxy server 30 in step S103, and transmits the trying response message to the UAC 10 in step S105.

The proxy server 30 transmits the INVITE request message to the UAS 40 in step S107, and transmits the trying response message to the proxy server 20 in step S109.

The UAS 40 that receives the INVITE request message transmits the ringing response message to the proxy server 30 in step S111. Next, the proxy server 30 that receives the ringing response message transmits the ringing response message to the proxy server 20 in step S113, and the proxy server 20 transmits the ringing response message to the UAC 10 in step S115.

If the UAS 40 accepts a call, the UAS 40 transmits the OK response message to the UAC 10 via the proxy server 30 and the proxy server 20 in steps S117, S119 and S121.

After the UAC 10 that receives the OK response message transmits the ACK message to the UAS 40 in S123, the media session is generated between the UAC 10 and the UAS 40 in step S125.

Next, the UAC 10 trying to close the call transmits the BYE request message to the UAS 40 in step S127. After the UAS 40 transmits the OK response message to the UAC 10, the media session is ended and the call is closed.

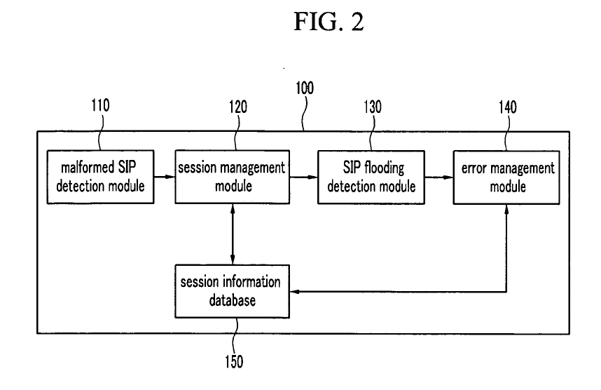

An SIP exception detection module according to an exemplary embodiment of the present invention will be now described with reference to FIG. 2.

FIG. 2 is a block diagram representing the SIP exception detection module according to an exemplary embodiment of the present invention.

As shown in FIG. 2, the SIP exception detection module 100 comprises a malformed SIP detection module 110, a session management module 120, an SIP flooding detection module 130, an error management module 140 and a session information database 150.

The SIP exception detection module 100 may be a inner module of the UAC 10, the proxy server 20, the proxy server 30 or the UAS 40.

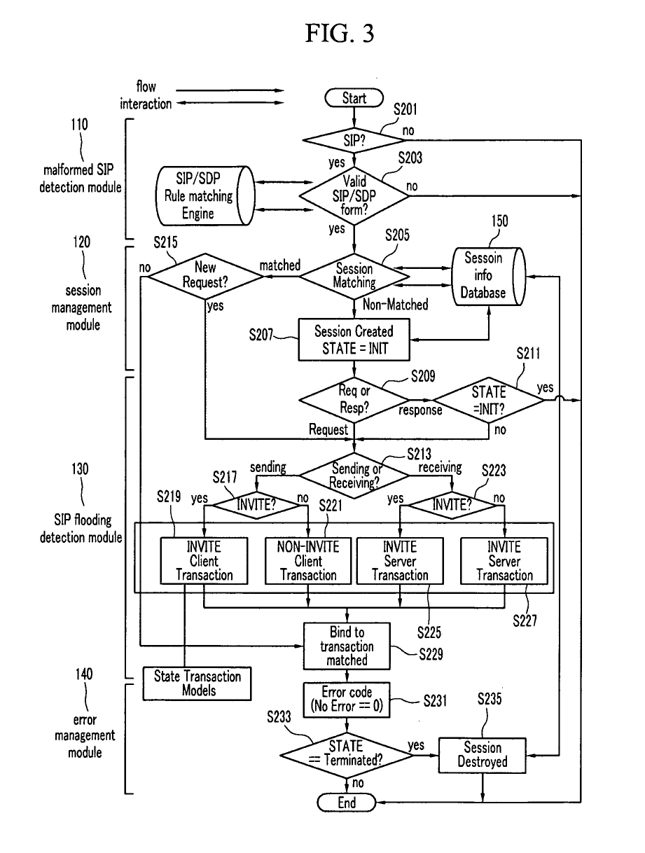

Each of the modules that the SIP exception detection module 100 comprises will be described with reference to FIG. 3.

FIG. 3 is a flow chart representing the SIP exception detection method according to an exemplary embodiment of the present invention.

Firstly, the malformed SIP detection module 110 acquires a packet and confirms whether the packet is an SIP packet or not in step S201. If the packet is not an SIP packet, the malformed SIP detection module 110 discards the packet.

If the packet is an SIP packet, the malformed SIP detection module 110 confirms whether the packet satisfies SIP packet rules or not in step S203. If the packet does not satisfy the SIP packet rules, the malformed SIP detection module 110 discards the packet. If the packet satisfies the SIP packet rules, the malformed SIP detection module 110 transmits the packet to the session management module 120.

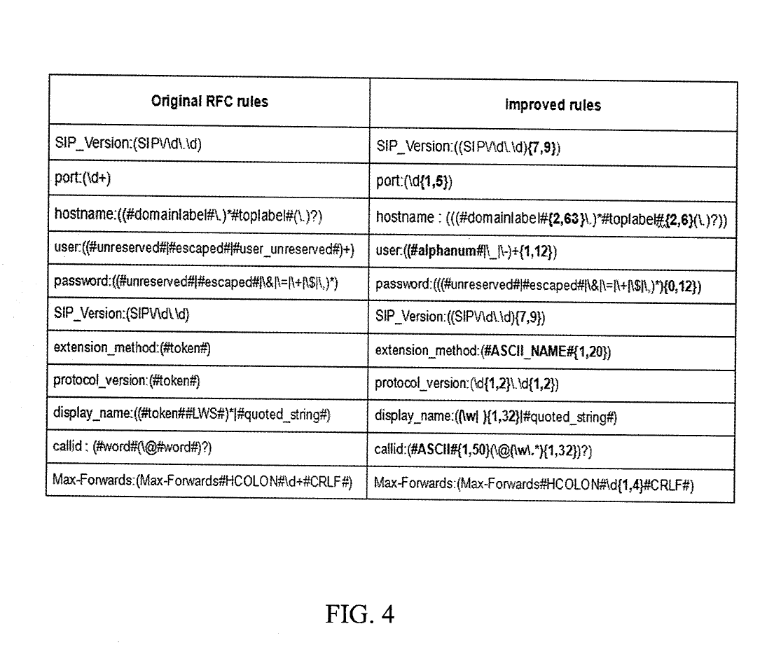

The SIP packet rules will be now described with reference to FIG. 4.

FIG. 4 is a drawing representing the SIP packet rules according to an exemplary embodiment of the present invention.

As shown in FIG. 4, the SIP packet rules according to the exemplary embodiment of the present invention are made by modifying rules according to RFC 3261. Modified parts are gothically represented in FIG. 4. The SIP packet rules according to the exemplary embodiment of the present invention comprise character length limit, special character length limit, etc.

The malformed SIP detection module 110 checks for violation of the character length limit, the special character limit, etc., of the header of the packet, so that it discards the packet if a violation exists. Concretely, the malformed SIP detection module 110 checks for an excess of the character length limit for each of fields of the header of the packet, so that if an excess exists it discards the packet. Also, the malformed SIP detection module 110 checks whether each of fields of the header of the packet includes a prohibited special character. If at least one of fields of the header includes a prohibited special character, the malformed SIP detection module 110 discards the packets.

Continually FIG. 3 will be now described.

The session management module 120 searches the session information database 150 to check generation of a session corresponding to the packet, in step S205.

If the session corresponding to the packet is not generated, in step S205, the session management module 120 generates the session corresponding to the packet, initiates a state of the session, and stores information on the session to the session information database 150 in step S207.

After establishing the session, the SIP flooding detection module 130 checks whether the packet is a request message or a response message in step S209.

If the packet is a response message, the SIP flooding detection module 130 checks whether the state of the session is an initial state in step S211. If the state of the session is the initial state, the SIP flooding detection module 130 ends the exception detection. If the state of the session is not the initial state, the SIP flooding detection module 130 checks whether the packet is a sending message or a receiving message in step S213.

On the other hand, if the session corresponding to the packet already exists in step S205, the session management module 120 checks whether the packet is a new request message of the session in step S215.

If the packet is a new request message of the session in step S215, the SIP flooding detection module 130 checks whether the packet is a sending message or a receiving message in step S213.

If the packet is the sending message in step S213, the SIP flooding detection module 130 checks whether the packet is the INVITE request message in step S217.

If the packet is an INVITE request message, the SIP flooding detection module 130 transacts the session corresponding to the packet as an INVITE client in step S219.

If the packet is not an INVITE request message, the SIP flooding detection module 130 transacts the session corresponding to the packet as a non-INVITE client in step S221.

If the packet is the receiving message in step S213, the SIP flooding detection module 130 checks whether the packet is an INVITE request message in step S223.

If the packet is an INVITE request message in step S223, the SIP flooding detection module 130 transacts the session corresponding to the packet as an INVITE server in step S225.

If the packet is not an INVITE request message in step S223, the SIP flooding detection module 130 transacts the session corresponding to the packet as a non-INVITE server in step S227.

Next, the SIP flooding detection module 130 manages the state of the session corresponding to the packet in step 229. On the other hand, even if the packet is not a new request message of the session in step 215, the SIP flooding detection module 130 manages the state of the session corresponding to the packet in step 229.

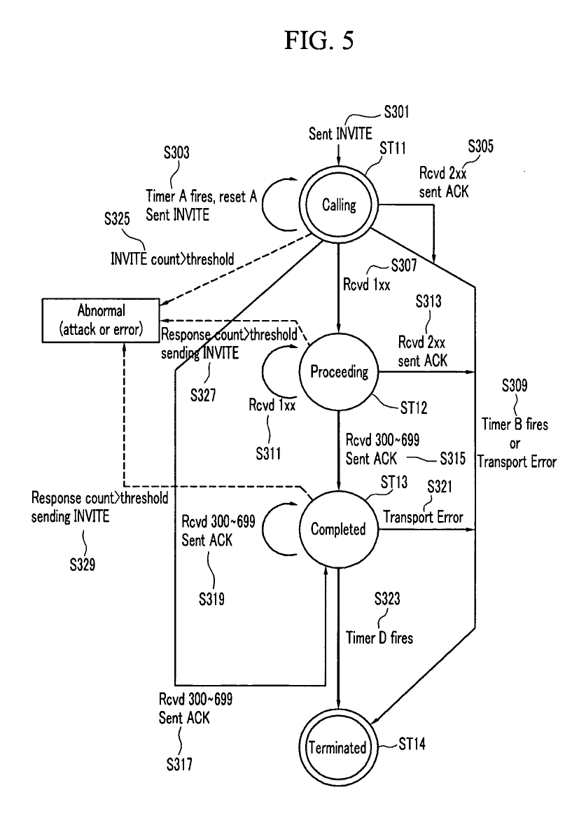

A method for the SIP flooding detection module 130 to manage the state of the session according to an exemplary embodiment of the present invention will be now described with reference to FIG. 5 to FIG. 8.

FIG. 5 is a state transition diagram representing the method for the INVITE client to manage the state of the session according to an exemplary embodiment of the present invention.

As shown in FIG. 5, a calling state ST11, a proceeding state ST12, a completed state ST13 and a terminated state ST14 may be cited as states of the session of the INVITE client.

First, if the INVITE client sends the INVITE request message in the initial state, the INVITE client transits the state of the session to the calling state ST11 in step S301.

If the timer A expires in the calling state ST11, the INVITE client resets the timer A and resends the INVITE request message in step S303. At this time, according to the RFC 3261, the timer A expires after T1 (500 milliseconds).

If the INVITE client receives the success response message corresponding to the response code of 2XX in the calling state ST11, the INVITE client sends the ACK message and transits the state of the session to the terminated state ST14 in step S305.

If the INVITE client receives the provisional response message corresponding to the response code of 1XX in the calling state ST11, the INVITE client transits the state of the session to the proceeding state ST12 in step S307.

If a timer B expires in the calling state ST11 or the INVITE client sends an error, the INVITE client transits the state of the session to the terminated state ST14 in step S309. At this time, according to the RFC 3261, the timer B expires after T1*64 milliseconds.

If the INVITE client receives the provisional response message corresponding to the response code of 1XX in the proceeding state ST12, the INVITE client maintains the state of the session as the proceeding state ST12 in step S311.

If the INVITE client receives the success response message corresponding to the response code of 2XX in the proceeding state ST12, the INVITE client sends the ACK message and transits the state of the session to the terminated state ST14 in step S313.

If the INVITE client receives the response message corresponding to the response code from 300 to 699 in the proceeding state ST12, the INVITE client sends the ACK message and transits the state of the session to the completed state ST13 in step S315.

On the other hand, if the INVITE client receives the response message corresponding to the response code from 300 to 699 in the calling state ST11, the INVITE client sends the ACK message and transits the state of the session to the completed state ST13 in step S317.

If the INVITE client receives the response message corresponding to the response code from 300 to 699 in the completed state ST13, the INVITE client sends the ACK message and maintains the state of the session as the completed state ST13 in step S319.

If the INVITE client sends an error in the completed state ST13, the INVITE client transits the state of the session to the terminated state ST14 in step S321.

If the timer D expires in the completed state ST13, the INVITE client transits the state of the session to the terminated state ST14 in step S323. At this time, according to the RFC 3261, the timer D expires after 32,000 milliseconds.

If the INVITE client sends the INVITE request messages more than the predetermined number of times in the calling state ST11, the INVITE client determines the message as an abnormal message, an attack or an error in step S325.

If the INVITE client receives the response messages or sends the INVITE request messages more than the predetermined number of times in the proceeding state ST12, the INVITE client determines the message as an abnormal message, an attack or an error in step S327.

If the INVITE client receives the response messages or sends the INVITE request messages more than the predetermined number of times in the completed state ST13, the INVITE client determines the message as an abnormal message, an attack, or an error in step S329.

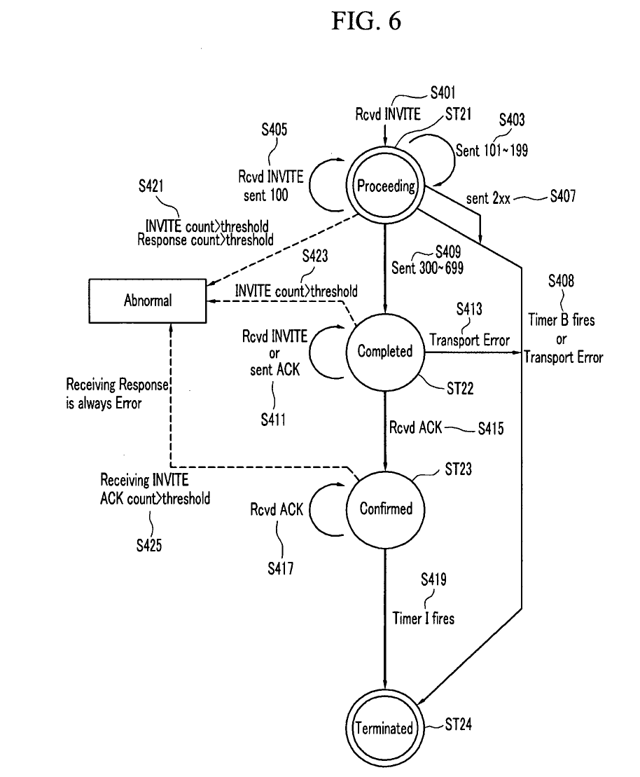

FIG. 6 is a state transition diagram representing the method for the INVITE server to manage the state of the session according to an exemplary embodiment of the present invention.

As shown in FIG. 6, a proceeding state ST21, a completed state ST22, a confirmed state ST23, and a terminated state ST24 may be cited as states of the session of the INVITE server.

If the INVITE server receives the INVITE request message in the initial state, the INVITE server transits the state of the session to the proceeding state ST21 in step S401.

If the INVITE server receives the provisional response message corresponding to the response code of 1XX in the proceeding state ST21, the INVITE server maintains the state of the session as the proceeding state ST21 in step S403.

If the INVITE server re-receives the INVITE request message in the proceeding state ST21, the INVITE server sends the trying response message corresponding to the response code of 100 and maintains the state of the session as the proceeding state ST21 in step S405.

If the INVITE server sends the success response message corresponding to the response code of 2XX in the proceeding state ST21, the INVITE server transits the state of the session to the terminated state ST24 in step S407.

If the timer B expires in the proceeding state ST21 or the INVITE server sends an error, the INVITE server transits the state of the session to the terminated state ST24 in step S408.

If the INVITE server sends the response message corresponding to the response code from 300 to 699 in the proceeding state ST21, the INVITE server transits the state of the session to the completed state ST22 in step S409.

If the INVITE server receives the INVITE request message or sends the trying response message corresponding to the response code of 100 in the completed state ST22, the INVITE server transits the state of the session to the completed state ST22 in step S411.

If the INVITE server sends an error in the completed state ST22, the INVITE server transits the state of the session to the terminated state ST24 in step S413.

If the INVITE server receives the ACK message in the completed state ST22, the INVITE server transits the state of the session to the confirmed state ST23 in step S415.

If the INVITE server re-receives the ACK message in the confirmed state ST23, the INVITE server maintains the state of the session to the confirmed state ST23 in step S417.

If a timer I expires in the confirmed state ST23, the INVITE server transits the state of the session to the terminated state ST24 in step S419. At this time, according to the RFC 3261, the timer I expires after T4 (4000 milliseconds).

If the INVITE server receives the INVITE request messages or sends the response messages more than the predetermined number of times in the proceeding state ST21, the INVITE server determines the message as an abnormal message, an attack or an error in step S421.

If the INVITE server receives the INVITE request messages more than the predetermined number of times in the completed state ST22, the INVITE server determines the message as an abnormal message, an attack, or an error in step S423.

If the INVITE server receives the INVITE request messages or sends the response messages more than the predetermined number of times in the confirmed state ST23, the INVITE server determines the message as an abnormal message, an attack, or an error in step S425.

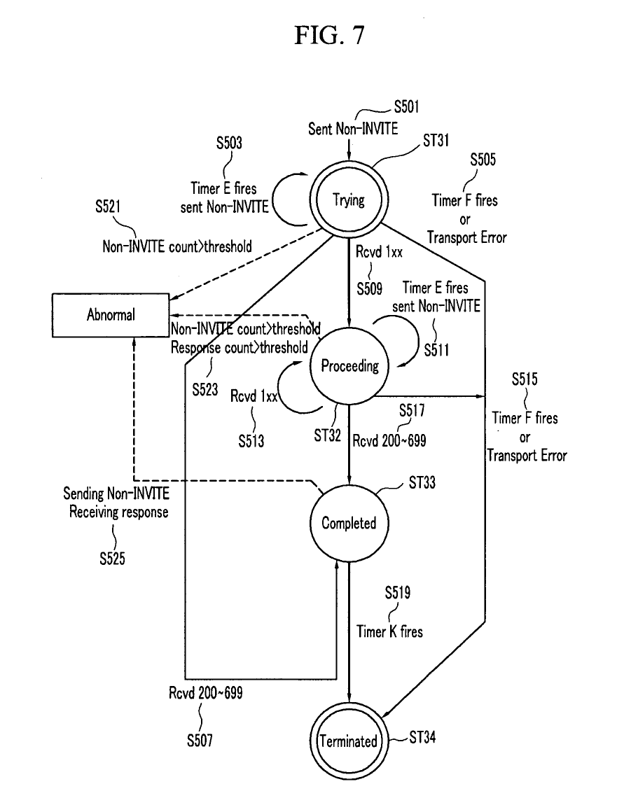

FIG. 7 is a state transition diagram representing the method for the non-INVITE client to manage the state of the session according to an exemplary embodiment of the present invention.

As shown in FIG. 7, a trying state ST31, a proceeding state ST32, a completed state ST33 and a terminated state ST34 may be cited as states of the session of the non-INVITE client.

If the non-INVITE client sends the non-INVITE request message corresponding to the request message except the INVITE request message in the initial state, the non-INVITE client transits the state of the session to the trying state ST31 in step S501.

If a timer E expires in the trying state ST31, the non-INVITE client re-sends the non-INVITE request message and maintains the state of the session to the trying state ST31 in step S503. At this time, according to the RFC 3261, the timer E expires after T1 (500 milliseconds).

If a timer F expires or the non-INVITE server sends an error in the trying state ST31, the non-INVITE server transits the state of the session to the terminated state ST34 in step S505. At this time, according to the RFC 3261, the timer F expires after T1*64 milliseconds.

If the non-INVITE client receives the response message corresponding to the response code from 200 to 699 in the trying state ST31, the non-INVITE client transits the state of the session to the completed state ST33 in step S507.

If the non-INVITE client receives the provisional response message corresponding to the response code of 1XX in the trying state ST31, the non-INVITE client transits the state of the session to the proceeding state ST32 in step S509.

If the timer E expires in the proceeding state ST32, the non-INVITE client sends the non-INVITE request message and maintains the state of the session to the proceeding state ST32 in step S511.

If the non-INVITE client receives the provisional response message corresponding to the response code of 1XX in the proceeding state ST32, the non-INVITE client maintains the state of the session as the proceeding state ST32 in step S513.

If the timer F expires or the non-INVITE client sends an error in the proceeding state ST32, the non-INVITE client transits the state of the session to the terminated state ST34 in step S515.

If the non-INVITE client receives the response message corresponding to the response code from 200 to 699 in the proceeding state ST32, the non-INVITE client transits the state of the session to the completed state ST33 in step S517.

If the timer K expires in the completed state ST33, the non-INVITE client transits the state of the session to the terminated state ST34 in step S519. At this time, according to the RFC 3261, the timer K expires after T4 (4,000 milliseconds).

If the non-INVITE client sends the non-INVITE request messages more than the predetermined number of times in the trying state ST31, the non-INVITE client determines the message as an abnormal message, an attack, or an error in step S521.

If the non-INVITE client sends the non-INVITE request messages or receives the response messages more than the predetermined number of times in the proceeding state ST32, the non-INVITE client determines the message as an abnormal message, an attack or an error in step S523.

If the non-INVITE client sends the non-INVITE request messages or receives the response messages in the completed state ST33, the non-INVITE client determines the message as an abnormal message, an attack, or an error in step S525.

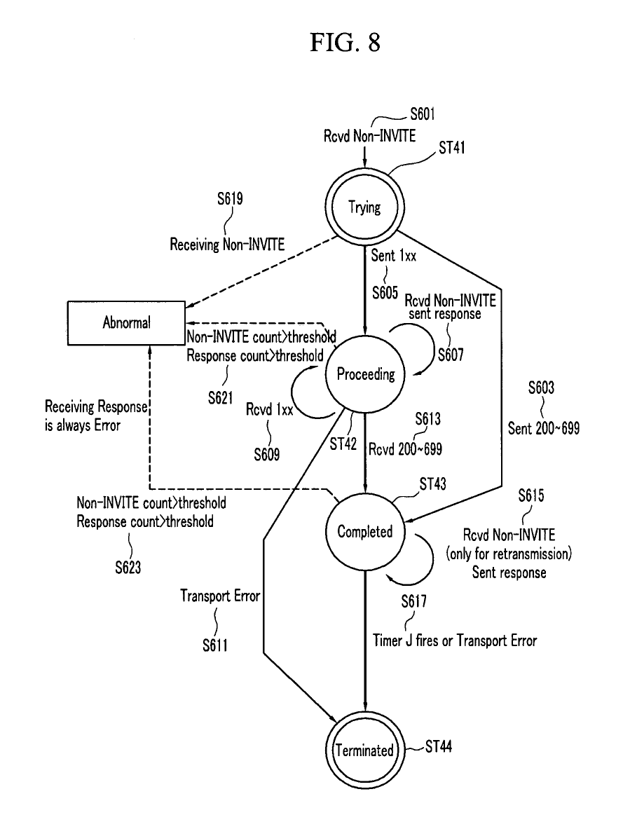

FIG. 8 is a state transition diagram representing the method for the non-INVITE server to manage the state of the session according to an exemplary embodiment of the present invention.

As shown in FIG. 8, a trying state ST41, a proceeding state ST42, a completed state ST43, and a terminated state ST44 may be cited as states of the session of the non-INVITE server.

If the non-INVITE server receives the non-INVITE request message in the initial state, the non-INVITE server transits the state of the session to the trying state ST41 in step S601.

If the non-INVITE server sends the response message corresponding to the response code from 200 to 699 in the trying state ST41, the non-INVITE server transits the state of the session to the completed state ST43 in step S603.

If the non-INVITE server sends the provisional response message corresponding to the response code of 1XX in the trying state ST41, the non-INVITE server transits the state of the session to the proceeding state ST42 in step S605.

If the non-INVITE server receives the non-INVITE request message in the proceeding state ST42, the non-INVITE server sends the response message and maintains the state of the session to the proceeding state ST42 in step S607.

If the non-INVITE server sends the provisional response message corresponding to the response code of 1XX in the proceeding state ST42, the non-INVITE server maintains the state of the session as the proceeding state ST42 in step S609.

If the non-INVITE server sends an error in the proceeding state ST42, the non-INVITE server transits the state of the session to the terminated state ST44 in step S611.

If the non-INVITE server sends the response message corresponding to the response code from 200 to 699 in the proceeding state ST42, the non-INVITE server transits the state of the session to the completed state ST43 in step S613.

If the non-INVITE server receives the non-INVITE request message in the completed state ST43, the non-INVITE server sends the response message and maintains the state of the session to the completed state ST43 in step S615.

If a timer J expires or the non-INVITE server sends an error in the completed state ST43, the non-INVITE server transits the state of the session to the terminated state ST44 in step S617. At this time, according to the RFC 3261, the timer J expires after T1*64 milliseconds.

If the non-INVITE server receives the non-INVITE request messages in the trying state ST41, the non-INVITE server determines the message as an abnormal message, an attack, or an error in step S619.

If the non-INVITE server receives the non-INVITE request messages or sends the response messages more than the predetermined number of times in the proceeding state ST42, the non-INVITE server determines the message as an abnormal message, an attack or an error in step S621.

If the non-INVITE server receives the non-INVITE request messages or sends the response messages more than the predetermined number of times in the completed state ST43, the non-INVITE server determines the message as an abnormal message, an attack or an error in step S623.

Continually FIG. 3 will be now described.

The error management module 140 receives information on the error from the SIP flooding detection module 130 in step S231. If the error management module 140 determines the received packet as an error, the error management module 140 discards the packet.

Next, in step S233, the error management module 140 determines whether the state of the session is the terminated state.

If the state of the session is the terminated state, the error management module 140 ends the session in step S235, and terminates proceeding with the packet.

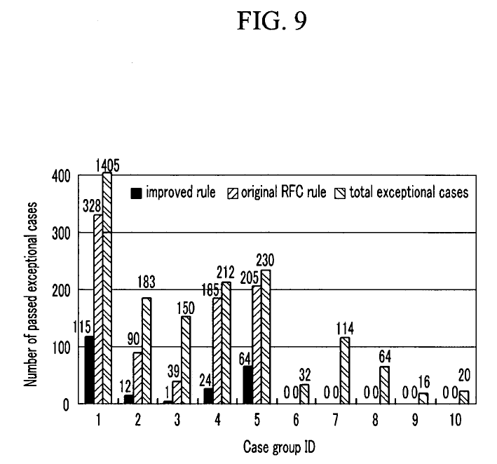

The effectiveness of the method for detecting errors of the SIP packet according to an exemplary embodiment of the present invention will be now described with reference to FIG. 9.

FIG. 9 is a graph showing the effectiveness of the exemplary embodiment of the present invention.

With reference to FIG. 9, detecting exceptions according to the exemplary embodiment of the present invention is more effective than detecting exceptions according to the RFC 3261 defining the SIP.

In particular, to prove the effectiveness of the exemplary embodiment of the present invention, experiments using an SIP packet generator and an SIP attack detector were executed. 2,436 packets with altered headers were used for the abnormal SIP message attack. In the case of Simple RFC rules, 34.9% of attack packets were detected. However, in case of the exemplary embodiment of the present invention, only 10.67% of attack packets were not detected. Since normal packets exist among packets that were not detected, almost 100% of abnormal SIP messages may be detected.

For an experiment of an SIP flooding attack, five services that are free and are based on the SIP among VoIP services that are plentifully used in the whole world were selected. By analyzing transmission of the SIP packets in a normal situation with these services, a standard point of the SIP flooding attack may be established in the state transaction model. In normal cases the number of SIP packets that are transmitted or received in each of states is not over 8 per second per state. By regarding this value as the standard point, the possibility of detection of the SIP flooding attack was experimentally evaluated with 5 pps (packets per second) values of 1 pps, 3 pps, 5 pps, 10 pps and 34 pps. The case of 1 pps was not regarded as the SIP flooding attack. The cases of 3 pps, 5 pps, 10 pps and 34 pps were regarded as SIP flooding attacks after 3.1 seconds, 1.9 seconds, 0.8 seconds, and 0.2 seconds, respectively. Since the standard point is 8 pps per 1 state, the cases over 5 pps were regarded as SIP flooding attacks.

According to the exemplary embodiment of the present invention, abnormal packets may be easily detected in the voice service based on packets such as VoIP.

Also, according to the exemplary embodiment of the present invention, the abnormal SIP message attack and the SIP message flooding attack may be easily detected.

The above-described methods and apparatuses are not only realized by the exemplary embodiment of the present invention, but, on the contrary, are intended to be realized by a program for realizing functions corresponding to the configuration of the exemplary embodiment of the present invention or a recording medium for recording the program.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A computer-readable medium that stores instructions executable by at least one processor to perform a method comprising:
acquiring a packet;
determining whether a header of the packet violates a first rule;
if the header of the packet does not violate the first rule, confirming a session of the packet;
confirming a state of the session;
determining whether acquiring the packet in the state of the session violates a second rule; and
if the second rule is violated, considering the packet to be abnormal.

2. The computer-readable medium of claim 1, wherein the determining whether acquiring the packet in the state of the session violates the second rule comprises:
determining whether the packet is acquired more than a predetermined number of times in the state of the session by acquiring the packet,
wherein the considering the packet to be abnormal comprises:
if the packet is acquired more than the predetermined number of times in the state of the session, considering the packet to be abnormal.

3. The computer-readable medium of claim 2, wherein the determining whether the header of the packet violates the first rule comprises:
determining whether each of fields of the header of the packet is out of a defined character length; and
determining whether each of the fields of the header of the packet includes at least one prohibited character.

4. The computer-readable medium of claim 3, wherein the method comprises:
if the state of the session is an initial state and a packet corresponding to the invite request message is sent, transiting the state of the session to a calling state,
wherein the determining whether the packet is acquired more than the predetermined number of times comprises:
determining whether the invite request message is sent more than the predetermined number of times in the calling state.

5. The computer-readable medium of claim 4, wherein the method comprises:
if the state is the calling state and a packet corresponding to a provisional response message is received, transiting the state to a proceeding state; and
if the state is the proceeding state and a packet corresponding to a response message corresponding to an SIP response code from 300 to 699 is received, transiting the state to a completed state,
wherein the determining whether the packet is acquired more than the predetermined number of times comprises:
determining whether a packet corresponding to a response message is received more than the predetermined number of times in the proceeding state, and
determining whether a packet corresponding to a response message is received more than the predetermined number of times in the completed state.

6. The computer-readable medium of claim 3, wherein the method comprises:
if the state is an initial state and a packet corresponding to an invite request message is received, transiting the state to a proceeding state,
wherein the determining whether the packet is acquired more than the predetermined number of times comprises:
determining whether the invite request message is received more than the predetermined number of times or a response message is sent more than the predetermined number of times in the proceeding state.

7. The computer-readable medium of claim 6, wherein the method comprises:
if the state is the proceeding state and a packet corresponding to a response message corresponding to an SIP response code from 300 to 699 is received, transiting the state to a complete state; and
if a packet corresponding to an ACK message is received in the completed state, transiting the state to a confirmed state,
wherein the determining whether the packet is acquired more than the predetermined number of times comprises:
determining whether an invite request message is received more than the predetermined number of times in the completed state, and
determining whether the invite request message is received or the ACK message is received more than the predetermined number of times in the confirmed state.

8. The computer-readable medium of claim 3, wherein the method comprises:
if the state is an initial state and a packet corresponding to an non-invite request message is sent, transiting the state to a trying state,
wherein the determining whether the packet is acquired more than the predetermined number of times comprises:
determining whether the non-invite request message is sent more than the predetermined number of times in the trying state.

9. The computer-readable medium of claim 8, wherein the method comprises:
if a packet corresponding to a provisional response message is received in the trying state, transiting the state to a proceeding state; and
if a packet corresponding to a response message corresponding to an SIP response code from 200 to 699 is received in the proceeding state, transiting the state to a completed state, and
wherein the determining whether the packet is acquired more than the predetermined number of times comprises:
determining whether a non-invite request message is sent more than the predetermined number of times or a response message is received more than the predetermined number of times in the proceeding state, and
determining whether a non-invite request message is sent or a response message is received in the completed state.

10. The computer-readable medium of claim 3, wherein the method comprises:
if the state is an initial state and a non-invite request message is received, transiting the state to a trying state,
wherein the determining whether the packet is acquired more than the predetermined number of times comprises:
determining whether the non-invite request message is received in the trying state.

11. The computer-readable medium of claim 10, wherein the method comprises:
if a packet corresponding to a provisional response message is sent in the trying state, transiting the state to a proceeding state; and
if a packet corresponding to a response message corresponding to an SIP response code from 200 to 699 is sent in the proceeding state, transiting the state to a completed state,
wherein the determining whether the packet is acquired more than the predetermined number of times comprises:
determining whether a non-invite request message is received more than the predetermined number of times or a response message is sent more than the predetermined number of times in the proceeding state, and
determining whether a non-invite request message is received more than the predetermined number of times or a response message is sent more than the predetermined number of times in the completed state.

12. A method for detecting an abnormal packet, comprising:
acquiring a packet for session establishment;
confirming a session to which the packet belongs;
confirming a state of the session;
determining whether the packet is received more than a predetermined number of times in the state of the session by acquiring the packet; and
if the packet is received more than a predetermined number of times in the state of the session, considering the packet to be abnormal.

13. The method of claim 12, further comprising:
if each of fields of the header of the packet is out of the defined character length, discarding the packet.

14. The method of claim 13, further comprising:
if each of fields of the header of the packet includes at least one prohibited character, discarding the packet.

15. The method of claim 14, further comprising:
if the packet is considered to be abnormal, discarding the packet.

16. A method for detecting an abnormal packet, comprising:
acquiring a packet for session establishment;
determining whether each of fields of the header of the packet is out of a defined character length;
determining whether each of the fields of the header of the packet includes at least one prohibited character;
if the each of fields is not out of the defined character length and does not include at least one prohibited character, confirming a session to which the packet belongs;
confirming a state of the session;
determining whether acquiring the packet in the state of the session violates a predetermined rule; and
if the predetermined rule is violated, considering the packet to be abnormal.

17. The method of claim 16, wherein the determining whether acquiring the packet in the state of the session violates the predetermined rule comprises:
determining whether the packet is acquired more than a predetermined number of times in the state of the session by acquiring the packet,
wherein the considering the packet to be abnormal comprises:
if the packet is acquired more than the predetermined number of times in the state of the session, considering the packet to be abnormal.
